(19) United States
(12) Patent Application Publication
(10) Pub. No.: US 2026/0336265 A1
(43) Pub. Date: Oct. 29, 2026

(54) PROCESS TO COAT LAMINATED GLASS PANELS AND COATED LAMINATED GLASS PANELS

(71) Applicant: AURYS INDUSTRIES, Carentan-les-Marais (FR)

(72) Inventors: Samir BOU OBEID, GOUVIEUX (FR); Franck MOLLARD, BAYEUX (FR)

(21) Appl. No.: 19/111,593

(22) PCT Filed: Sep. 11, 2023
(86) PCT No.: PCT/EP2023/074897

§ 371 Date: Mar. 13, 2025

(30) Foreign Application Priority Data
Sep. 16, 2022 (FR) FR2209325

(51) Int. Cl. B32B 17/10; E06B 9/24

(52) U.S. Cl. CPC B32B 17/10247; B32B 17/10036; B32B 17/10357; B32B 17/10385; B32B 17/10761; E06B 9/24

(57) ABSTRACT

A method of coating a laminated glass panel comprises a laminated glass panel to be coated is provided, comprising at least two sheets of glass assembled by means of a polymer interlayer material, a fluid decorative material is provided, a chemical hardener or a cross linking catalyst is incorporated into the fluid decorative material in a ratio P_cata between the mass of the chemical hardener or cross linking catalyst and the mass of the decorative material in the determined fluid state, at least one decorative coating layer is formed by applying the decorative material to the upper face of the laminated glass panel to be coated, the decorative coating layer is dried by heating by means of a drying system, the set point temperature of which is greater than or equal to 100 °C and less than 140 °C.

### FIELD OF THE INVENTION

This invention relates to a process for manufacturing a glass coated with a decorative layer and to such glass.

More specifically, the invention relates to a process for coating laminated glass panels with a decorative layer such as a reflective layer or a lacquer, and to the coated laminated glass panel thus obtained.

### TECHNOLOGICAL BACKGROUND

In the field of glass with decorative coating, two types of decorative coating are particularly popular: light-reflecting coatings that give the glass a mirror-like appearance, and “lacquer”-type decorative coatings formed using a resin-rich paint with a so-called “stretched” appearance. Thus, a mirror typically consists of monolithic glass, typically between 2 and 8 mm thick, coated with a layer of silver to give it its reflective properties. The thickness of the silver layer is typically of the order of a few tens of nanometres and its density is generally at least 700 mg/m². To improve the chemical and mechanical strength of the silver layer, it can be covered with a protective varnish, usually several micrometres thick.

Lacquered glass on the other hand, typically consists of monolithic glass, typically between 2 and 12 mm thick, coated with a layer of decorative “lacquer” paint—usually several micrometres thick—which gives it the desired aesthetic appearance and satisfactory chemical and mechanical strength.

Although these monolithic glass coating processes are satisfactory from an aesthetic point of view, they do not provide sufficient mechanical strength for certain applications, especially in the building sector.

The safety of coated monolithic glass obtained using conventional processes can be improved using an adhesive anti-shatter film placed on the back of the glass which holds the shards of glass in place in the event of breakage. The mechanical performances of such a structure remain limited since the risk of breakage is not, or is only slightly, modified by the presence of the anti-shatter film.

In the glass industry, glass is also known to be tempered to improve its mechanical properties. Tempered glass cannot be re-cut after tempering. Were we to consider a decorative coating for tempered glass, we would be limited by the shape of the piece of tempered glass before coating. This choice is obviously very limited for applications in the construction sector such as cupboard doors, tables and wall surfaces, which often have to be made to measure.

In the field of glass, it is still common practice to laminate glass to improve its mechanical properties. Laminated glass is an assembly of sheets of glass and plastic interlayers, particularly in the form of film, generally made from polyvinyl butyral (PVB) or ethylene vinyl acetate (EVA). The presence of the interlayer material increases the mechanical strength and prevents shards if the glass breaks.

Various processes have been described for the production of laminated glass mirrors or lacquered laminated glass, with the decorative layer sandwiched between two sheets of glass. Document GB224160 in particular describes a process for obtaining laminated glass mirrors in which:
a reflective coating is deposited on a first sheet of glass,
then a second sheet of glass is bonded to the first sheet using an adhesive such as polyvinyl butyral (PVB) the reflective coating being thus sandwiched between the two sheets of glass.

Based on such a process, it is not possible to simply reverse the order of the components to place the reflective coating on an external face of the final product. This is because, on the one hand, the reflective coating (or any other decorative coating) positioned in that way would then be mechanically damaged by the calendering or transport rollers used to assemble the two sheets, and on the other hand, the autoclaving phase on an industrial scale entails a risk of damaging the coatings of the layers of a given panel and of the glass panels sticking together. In addition, the optical defects of mirrors formed by the process described in GB224160 are determined by those of the glass layer on which the reflective coating is deposited. Similarly, WO2009/081077 describes a lacquered laminated glass in which a layer of lacquer is sandwiched between two sheets of glass, the assembly being subjected to heat treatment under pressure to provide the bond between the sheets of glass. Such a process requires the use of a lacquer that is resistant to heat treatment under pressure, which limits the choice of colours. Furthermore, the proper bonding of the PVB can be impacted, particularly in the case of varnishes with water-based solvents. Thus creating a risk of future delamination of the product. The purpose of the invention is thus to propose a process for coating a laminated glass panel with a decorative layer making it possible to obtain a coated laminated glass panel with impact and/or perforation resistance and an ability to keep shards in place that are at least as good as those obtained by the processes of the prior art and with optical and decorative properties that are improved compared to the processes of the prior art.

### BRIEF DESCRIPTION OF THE INVENTION

Thus, the invention relates to a method of coating laminated glass panels comprising:
a laminated glass panel to be coated is provided, comprising at least two sheets of glass and in which at least two successive sheets of glass are assembled by means of a polymer interlayer material forming an interlayer after assembly, the laminated glass panel to be coated having at least one upper face to be coated;
a fluid decorative material is supplied;
a chemical hardener or a cross-linking catalyst is incorporated into the fluid decorative material in a ratio of P_cata between the mass of the chemical hardener or cross-linking catalyst and the mass of the decorative material in the determined fluid state;
at least one decorative coating layer is formed by applying the decorative material in a fluid state in which the chemical hardener or the cross-linking catalyst is incorporated to the upper face of the laminated glass panel to be coated;
the decorative coating layer is dried by heating the laminated glass panel thus coated by means of a drying system, the set point temperature of which is greater than or equal to 100 °C and less than 140 °C.

According to one embodiment, the process may comprise a step in which the heating time (t_chauff) of the laminated glass panel at the set point temperature (T_ext) and/or the ratio P_cata of the mass of the chemical hardener or cross-linking catalyst and the mass of the decorative material in the fluid state during incorporation is determined depending on said set point temperature (T_ext).

Thanks to these measures, it is possible to manufacture coated laminated glass panels industrially without bubbling or yellowing of the interlayer material using laminated glass panels that are already assembled.

According to one embodiment of the process for coating laminated glass panels, the polymer interlayer material can be chosen from amongst polyvinyl butyral, ethylene vinyl acetate, an ionoplast polymer, thermoplastic polyurethane and a casting resin.

These different polymer interlayer materials have different characteristics in terms of refractive index, mechanical strength and hydrophobicity, making it possible to modulate the optical and/or mechanical and/or moisture resistance properties of the coated laminated glass panel depending on its future use.

The coating process can also be used to manufacture a mirror type glass panel and lacquered glass with a reduced carbon footprint over the life of the product. Laminated glass is in the order of five times stronger and a hundred times more rigid than monolithic glass. It is therefore to be expected that laminated glass mirrors/lacquered panels will be replaced less frequently than prior art mirrors/lacquered panels.

According to one embodiment of the process for coating laminated glass panels, at least one decorative coating layer can consist of either a layer of reflective material and one or more layers of protective varnish or one or more layers of lacquer and optionally one or more layers of protective varnish.

In particular, this arrangement makes it possible, using the same generic process, to form laminated glass panels of the mirror type and laminated glass panels coloured by means of a lacquer, these two types of laminated glass panels not having the same uses.

According to one embodiment of the process for coating laminated glass panels, the ratio P_cata of the mass of chemical hardener or cross-linking catalyst and the mass of decorative material in the fluid state is greater than 0.1%.

Such a proportion of chemical hardener makes it possible to limit the maximum surface temperature reached by the glass panel, so that the polymer interlayer material does not bubble or yellow and the cross-linking of the decorative coating layer is satisfactory with a limited drying time at this maximum surface temperature which is particularly acceptable in an industrial process.

According to one embodiment of the process for coating laminated glass panels:
if the set point temperature of the drying system (T_ext) is chosen in the range [100 °C, 120 °C], said heating time (t_chauff) in the drying system is greater than or equal to 7.5 minutes and said ratio P_cata is chosen in the range [0.1%; 5%],
and if the set point temperature of the drying system (T_ext) is chosen in the range [120 °C, 140 °C], said heating time (t_chauff) in the drying system is less than or equal to 7.5 minutes and greater than or equal to 3 minutes and said ratio P_cata is chosen in the range [0.1%; 5%]. These parameter ranges make it possible to obtain coated laminated glass panels without bubbling or yellowing of the polymer interlayer material, with particularly satisfactory cross-linking of the decorative coating layer, and in production times that are entirely compatible with industrial-scale, automated use. According to one embodiment of the process for coating laminated glass panels, the chemical hardener or cross-linking catalyst can be chosen from amongst acid catalysts and optionally from amongst hydrofluoric acid, phosphoric acid and para toluenesulphonic acid.

One of the advantages of these chemical hardeners and cross-linking catalysts is that they allow the cross-linking temperature to be lowered sufficiently to avoid bubbling problems. The invention also relates to laminated glass panels comprising at least two sheets of glass and in which at least two successive sheets of glass are joined together using a polymer interlayer material, the laminated glass panel having an upper outer face and a lower outer face, the two outer faces being oriented towards the outside of the panel, opposite to each other, in which the upper outer face of the laminated glass panel is coated with at least one decorative coating layer formed at least in part from an organic fluid decorative material which has been applied to the upper outer face of the laminated glass panel after the at least two successive sheets of glass have been joined by means of the polymer interlayer material.

According to one embodiment, the polymer interlayer material does not have any bubbling defects observable to the naked eye and the decorative coating layer withstands at least twenty passages in a rub test carried out by rubbing the surface of the decorative coating layer over a given distance using a cloth soaked in a solvent for the decorative coating layer. Such glass panels can be obtained by the process described in the invention and, thanks to the laminate, have good mechanical strength and shard retention, as well as improved optical and/or decorative properties compared to the coated glass panels of the prior art.

According to one embodiment of the laminated glass panels, the decorative coating layer withstands at least two hundred passes in the rub test. This level of resistance is suitable for the majority of coated laminated glass panel applications, particularly in the construction and furnishing sectors.

According to one embodiment of the laminated glass panels, at least one decorative coating layer consists of:
either one layer of reflective material and one or more layers of protective varnish,
or of one or more coats of lacquer and optionally one or more coats of protective varnish.

According to one embodiment of the laminated glass panels, the polymer interlayer material is tinted.

This makes it possible to obtain a tinted mirror of which the tint is controlled by that of the polymer interlayer material, of which the colouring is easy to implement and can be achieved in a wide range of colours.

According to one embodiment of the laminated glass panels, heating resources are incorporated in the polymer interlayer material or in at least one of the at least two sheets of glass. Finally, the invention relates to the use of laminated glass panels in the construction or furnishing sectors.

### BRIEF DESCRIPTION OF THE DRAWINGS

Embodiments of the invention will be described below with reference to the drawings, described briefly below:

FIG. 1 shows a side view of a laminated glass panel coated in accordance with the invention.

FIG. 2a is a photograph of a laminated glass panel coated by silvering and the deposition of a layer of protective varnish, the assembly being heated to 170 °C for 2 minutes, using a prior art process, on which the bubbling of the polymer interlayer material can be seen.

FIG. 2b is a photograph of the coated laminated glass panel in FIG. 2a, just after deposition of the protective varnish layer and just before the heating step according to the prior art process.

FIG. 3 shows the temperature profile followed by the outer surface of the decorative coating layer, monitored by means of six thermocouples distributed over this surface during the drying of the decorative coating layer according to a prior art process in the case of the coated laminated glass panel obtained in FIG. 2a.

FIG. 4 shows the temperature profiles followed by the outer surface of the decorative coating layer, monitored by means of six thermocouples distributed over this surface during the drying of the decorative coating layer according to the six heating profiles tested to obtain the results in Table 1.

FIG. 5 shows the theoretical evolution of the temperature T of the upper sheet of glass of a coated laminated glass panel in a simplified thermal model.

In the drawings, identical references designate identical or similar objects.

### DETAILED DESCRIPTION

The invention relates to a process for coating a glass panel comprising:
a laminated glass panel to be coated is provided, comprising at least two sheets of glass and in which at least two successive sheets of glass are assembled by means of a polymer interlayer material forming, after assembly, an interlayer layer 12, the laminated glass panel to be coated having at least one upper face 11a1;
a decorative material is provided in a fluid state;
a chemical hardener or a cross-linking catalyst is incorporated into the decorative material in the fluid state in a ratio P_cata between the mass of the chemical hardener or cross-linking catalyst and the mass of the decorative material in the fluid state;
at least one decorative coating layer 13 is formed by applying the decorative material in a fluid state in which the chemical hardener or the cross-linking catalyst is incorporated to the upper face 11a1 of the laminated glass panel to be coated;
the decorative coating layer is dried by heating the laminated glass panel thus coated by means of a drying system, the set point temperature T_ext of which is greater than or equal to 100 °C and less than 140 °C.

The heating time t_chauff of the laminated glass panel at set temperature T_ext and the ratio P_cata of the mass of the chemical hardener or cross-linking catalyst and the mass of the decorative material in the fluid state during incorporation can be chosen depending on set point temperature T_ext.

The P_cata ratio is preferably expressed as a percentage of the mass of the decorative material in the fluid state.

The laminated glass panel to be coated therefore comprises at least two sheets of glass, of which an upper sheet of glass 11a and a lower sheet of glass 11b are defined.

Any type of flat glass (or possibly curved glass using bending processes known to those skilled in the art, for coating curved surfaces) can be used for each of the sheets of glass.

Each sheet of glass is by definition monolithic.

In one embodiment, one or more of the at least two sheets of glass are produced by the “float” process, which produces a flat, smooth sheet of glass with very good accuracy, or by drawing or laminating processes.

In one embodiment, at least one or all of the sheets of glass are tempered.

In one embodiment, the upper sheet of glass 11a, one face of which will ultimately be coated with at least one layer of decorative coating 13 at the end of the process according to the invention, is not tempered glass. Tempered glass can have micro-deformations that can alter the decorative qualities of the coating, particularly if the coating is obtained by a silvering process.

If none of the sheets of glass are tempered, the laminated glass panels have the advantage of being able to be re-cut to the required dimensions and/or for edge trimming if their characteristics are not satisfactory at the end of the process.

There are no restrictions on the dimensions of the at least two sheets of glass apart from those linked to the manufacturing process for each of the sheets of glass and the assembly process.

In particular, the thickness of a sheet of glass can be between 2 and 12 mm (millimetres), or even more, depending on the end use of the coated laminated glass panel. For example, a thickness of 2 mm to 6 mm, or even 2 mm to 5 mm or 2 mm to 4 mm or even 2 mm to 3 mm, and in particular equal to 2 mm, 3 mm, 4 mm, 5 mm or 6 mm, for one or more of the at least two sheets of glass can be envisaged.

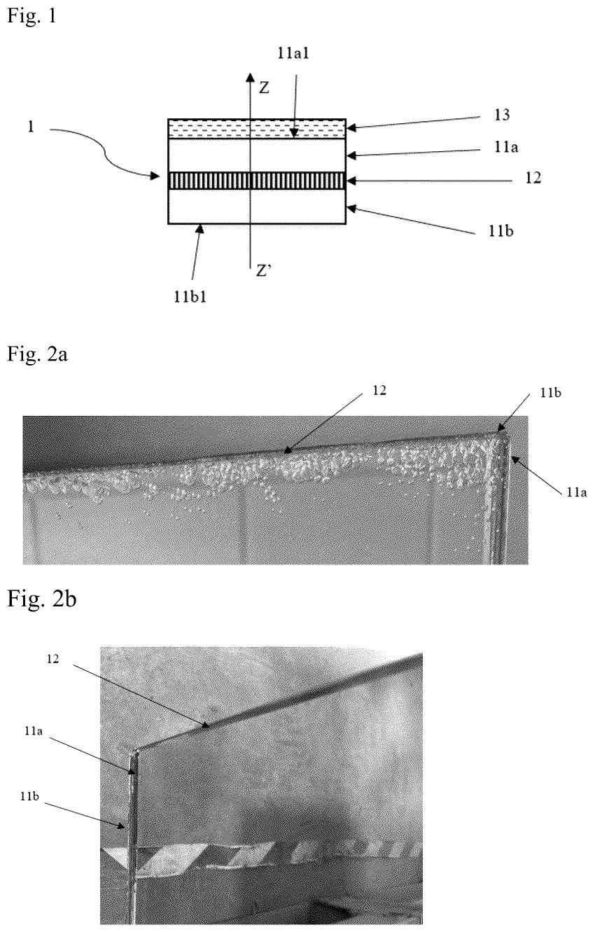

The at least two sheets of glass may or may not have identical thicknesses and/or compositions. The at least two sheets of glass are superimposed on one another in a stacking direction (Z′Z) and assembled two by two using at least one polymer interlayer material, so that after assembly at least one interlayer 12 is interlayered (or equivalently sandwiched) between at least two successive sheets of glass, as shown in FIG. 1.

Whatever the number of superimposed sheets of glass (two or more), the laminated glass panel to be coated therefore comprises at least:
an upper sheet of glass 11a, the outer face of which at assembly is intended to receive the coating and constitutes the so-called upper outer face 11a1 of the laminated glass panel to be coated,
and a lower sheet of glass 11b consisting of the sheet of glass the furthest away from the upper sheet of glass 11a in the stacking direction (Z′Z) and of which the face external to the assembly constitutes the so-called lower outer face 11b1 of the laminated glass panel to be coated.

The polymer interlayer material may comprise one or more polymers.

In particular, the polymer interlayer material can be polyvinyl butyral (PVB). The advantages of PVB include the following:
PVB has a refractive index close to that of soda-lime-silica glass commonly used in glazing, so the interlayer is invisible or virtually invisible.
PVB is also highly effective at absorbing impact and retaining the glass fragments if the glazing breaks.

It can also be ethylene vinyl acetate (EVA). The hydrophobic properties of EVA are of particular interest if the coated glass panel is to be installed in a humid environment or outdoors: the risk of delamination over time due to humidity is reduced by using EVA for the interlayer 12 of polymer material.

It is also possible to use an “ionoplast” polymer interlayer material, in particular of the SentryGlass® type, which makes it possible to form laminated glass that does not have bubble or yellowing defects even when exposed to high temperatures of up to 80 °C when used.

In another embodiment, the interlayer material can be thermoplastic polyurethane (also known as TPU or “Thermoplastic PolyUrethan”) or a casting resin (or equivalent CIP (“Cast in place”) resin).

The interlayer material can be tinted prior to assembly to give the laminated glass panel a specific colour combined with the decorative coating once the panel has been coated.

Once the laminated glass panel to be coated has been supplied, a decorative material in a fluid state is supplied.

The decorative material in the fluid state can in particular be in the liquid state with a greater or lesser viscosity, this viscosity being adapted to allow a layer of decorative material to be deposited on the laminated glass panel, for example by means of a roller or spray gun or even a curtain machine.

The decorative material can be a lacquer.

The fluid decorative material is preferably organic in nature, i.e. it comprises carbon, and preferably comprises a majority of carbon. The decorative material may comprise an organic binder, for example a hydrocarbon binder, a resin or a polymer.

A lacquer is a non-transparent coating, which can be translucent but is generally opaque, and which comprises, before drying, a solvent in which at least one pigment and at least one polymer resin are dissolved, as well as optional mineral fillers.

The function of the pigments is to create the desired colour and opacity.

The polymer resin acts as a binder: it binds the pigments and any mineral fillers after drying.

The binder is preferably acrylic resin-based. The binder can also be an alkyd resin or a polyurethane binder.

By way of example, the decorative material may be a Glassolux-type lacquer (produced by Fenzi®) or equivalent.

The lacquer can be applied, for example, using a curtain machine, roller or spray gun in one or more passes.

The choice of the number of passes to deposit the lacquer, and consequently the number of layers of lacquer, can be determined in particular by the required opacity and/or the required mechanical strength.

The thickness of the deposited lacquer can be between 10 and 100 micrometres.

The decorative material can also be a reflective material after drying.

The decorative material may, for example, comprise silver, which can be deposited by oxidoreduction reaction by bringing an ammoniacal silver nitrate solution into contact with a reducing agent solution.

The decorative material is therefore supplied in a fluid state, in that it includes one or more solvents.

In known processes for coating non-laminated glass with a decorative material in the fluid state, the fluid decorative material is deposited directly on one face of the non-laminated glass so as to form a decorative coating layer and this decorative coating layer is dried.

In a conventional lacquering process, the lacquer is dried by passing it through an oven at a temperature above 160 °C. Typically, Glassolux lacquers require heating for at least 2.5 minutes at a temperature of at least 160 °C.

Similarly, in a conventional silvering process, the layer of protective varnish is applied over the layer of reflective material, for example using a curtain varnisher, with the varnish being dried by passing through an oven so that the temperature reached on the surface of the layer of protective varnish is greater than 170 °C for at least two minutes.

In summary, the lacquers and varnishes conventionally used in the manufacture of mirrors are single-component paints that require sufficient thermal energy to cross-link and achieve the expected levels of performance in terms of chemical (corrosion) and mechanical (scratch) resistance, for which it is customary to keep the glass panel in an oven so that the temperature reached on the surface of the protective varnish layer is above 170 °C for at least two minutes.

Regardless of how the decorative coating layer is deposited, it can be seen that drying by heating to a high temperature is used in the processes for coating non-laminated glass conventionally used in the field of monolithic glass and is necessary to obtain good cross-linking of this decorative coating layer, and moreover within a time that is acceptable in an industrial manufacturing process.

Unfortunately, these processes cannot be applied directly to laminated glass panels, as the heating step causes the interlayer material to bubble.

FIG. 2a is a photograph of a laminated glass panel of the Stadip® 44.2 type produced by Saint-Gobain coated with a decorative coating of the silver layer+protective varnish type after conventional heat treatment, i.e. heating in an infra-red oven so that the surface temperature of the laminated glass panel is equal to 170 °C for a period of two minutes, FIG. 2b corresponding to the same laminated glass panel just before the heat treatment.

FIG. 2a shows that the prior art coating process causes bubbling of the interlayer material, including quite far from the edges, which is not present immediately before the heating step, as shown in FIG. 2b.

It is not cost-effective to consider such processes followed by a step to cut the edges and declassify them.

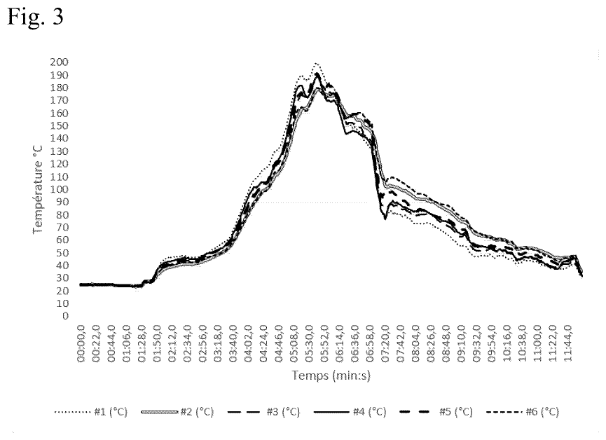

Throughout the heat drying step following the deposition of the decorative coating in the case of the glass panel in FIG. 2b, the temperature profile followed by the outer surface of the decorative coating layer was monitored by means of six thermocouples distributed over the surface. This profile is shown in FIG. 3.

FIG. 3 shows that all the points on the outer surface of the protective layer reach a temperature of over 170 °C for at least 30 seconds and a temperature of over 140 °C for at least 2 minutes and 30 seconds.

Besides the bubbling, drying by heat treatment can in some cases lead to the yellowing of the polymer interlayer material, which can be troublesome in particular cases of decorative coatings according to the invention. Yellowing is particularly to be avoided where the decorative coating is of the mirror type, as it alters the colour of the image reflected by the mirror. This problem can also be noticeable and troublesome if the decorative coating includes a light-coloured lacquer. It therefore appears essential to modify the methods of drying the decorative coating layer 13 of the prior art if the aim is to form a decorative coating layer 13 on an outer face of a laminated glass panel.

Applying the decorative layer to an outer face of the already formed laminated glass is a mandatory step in the process according to the invention, despite the difficulty of its implementation, because it has several advantages.

Firstly, it allows the appearance of a laminated glass panel manufactured beforehand, possibly on another production line, to be modified and the decorative coating to be chosen afterwards, eventually case by case.

Secondly, the superimposition of at least two sheets of glass under the decorative coating improves the optical quality of the coated laminated glass, particularly when the aim is to form a laminated glass mirror. Each sheet of glass has flatness defects with a pitch of the order of a metre and optical defects with a pitch of the order of 1 cm to 10 cm, but these cannot all be superimposed on each other when the two sheets of glass are assembled. The optical distortions of laminated glass coated on its outside are therefore less than if the coating had been sandwiched between the two sheets of glass.

The inventors first considered reducing the set point temperature T_ext of the drying system, and/or the maximum temperature reached on the surface of the laminated glass panel and/or the time during which this maximum surface temperature is reached (or the heating time t_chauff at the set point temperature, this heating time t_chauff being correlated to the maximum surface temperature reached and the time during which it is reached, as shown in example 2) in the case of a laminated, non-monolithic glass panel. A simple reduction of these parameters is not apparently possible, as it leads to insufficient cross-linking of the decorative coating layer 13, particularly—if applicable—the lacquer layer or the protective varnish layer, so that the decorative coating layer will not be sufficiently strong for its subsequent handling or use. For example, there are problems with the decorative coating layer 13 flaking off when a given coated laminated glass panel is handled and with coated laminated glass panels sticking together when they are passed through an autoclave, or even with insufficient corrosion resistance.

To overcome the technical problem of obtaining an adequately cross-linked decorative coating layer within an acceptable time for an industrial process (particularly for a continuous manufacturing process in which the laminated glass panels to be coated are moved at a constant speed along a production line), typically of the order of a few minutes or a few tens of minutes, the inventors therefore envisaged the use of chemical hardeners or chemical catalysts.

In particular, it can be envisaged to incorporate into the decorative material in the fluid state a total proportion of one or more cross linking catalysts and/or chemical hardeners P_cata equal to or greater than 0.1%, or even equal to or greater than 0.5% by weight, 1% by weight, 2% by weight of the decorative material in the fluid state, 2.5% by weight of the decorative material in the fluid state and optionally less than 10% by weight of the decorative material in the fluid state, or even less than 5% by weight of the decorative material in the fluid state.

The protective varnish can be, but is not limited to: off the shelf corrosion varnishes from suppliers such as FENZI (e.g. FENZI One coat LF 3 grey SG, FENZI one coat WBLF 6), VALSPAR (e.g. SK1420 or SK1440) or EUROCOATINGS (e.g. eurocoatings glasskin007).

In the case of a lacquer, this may include, but is not limited to, off the shelf lacquers from suppliers such as FENZI (e.g. glassolux NG lacquer), MADER (e.g. madercoat LRY168 and madercoat 572 lacquers) or VALSPAR (e.g. reference SK3875).

The chemical hardener or cross-linking catalyst can be chosen depending on the fluid decorative material.

In particular, an acid catalyst such as hydrofluoric acid, phosphoric acid, para toluenesulphonic acid or any other transesterification catalyst can be used.

The fluid decorative material in which at least one chemical hardener and/or at least one cross-linking catalyst has been incorporated is then deposited on the upper face 11a1 of the laminated glass panel to be coated so as to form at least one decorative coating layer 13.

The fluid decorative material can be deposited using a fluid material depositing system such as a curtain varnisher, roller or spray gun.

The thickness of the at least one decorative coating layer may be greater than 10 micrometres.

The decorative coating layer is then dried so that it cross-links and the solvents at least partially evaporate.

The proportion P_cata of chemical hardener or cross-linking catalyst must be chosen to allow the decorative coating to be applied in a fluid state, particularly during an industrial process. In particular, this proportion can be chosen to allow the decorative coating to be applied using a device such as a curtain machine.

In particular, it is not possible to inconsiderately increase the proportion of chemical hardener or cross-linking catalyst, as too high a proportion will cause the product to harden at too low a temperature and/or too quickly. In such a case, the decorative material does not remain in the fluid state long enough to allow it to be applied to the upper face 11a1 of the laminated glass panel to be coated.

Uncontrolled hardening also leads to the clogging of the pipes or conveying elements through which the decorative material must flow.

The time taken for the catalyst to harden was assessed by observation with the naked eye in the case where the cross-linking catalyst is para toluenesulphonic acid incorporated into the fluid decorative material which is One Coat LF3 from the Fenzi brand in a proportion P_cata expressed as a percentage of the weight of the fluid decorative material.

The results are shown in Table 3 below:

TABLE 3
Hardening time depending on the proportion
P_cata of cross-linking catalyst

| P_cata (%) | Hardening time (qualitative h) |
|---|---|
| 0.1 | >24 |
| 0.5 | >24 |
| 1 | >24 |
| 2.5 | >24 |
| 5 | >24 |
| 10 | 9-24 |
| 25 | 2 |
| 50 | 0.5 |

It can be seen that an excessive proportion of the chemical hardener or cross-linking catalyst leaves little time for subsequent stages of processing the fluid decorative material, particularly for its application to the laminated glass panel to be coated.

It is therefore necessary to find a compromise between the proportion of chemical hardener or cross-linking catalyst, the drying temperature and the drying time.

A proportion P_cata of chemical hardener or cross-linking catalyst less than or equal to 10% by weight of the fluid decorative material, or even 5% by weight of the fluid decorative material, or even 2.5% by weight of the fluid decorative material may be suitable for implementing the process according to the invention.

It is clear from these experiments that the use of chemical hardeners or chemical catalysts for the decorative coating layer of a laminated glass panel is not achieved without inventive activity: the inventors tested numerous temperature rise/fall profiles for the drying by heating of the laminated glass panel covered with a decorative coating layer before achieving a satisfactory result.

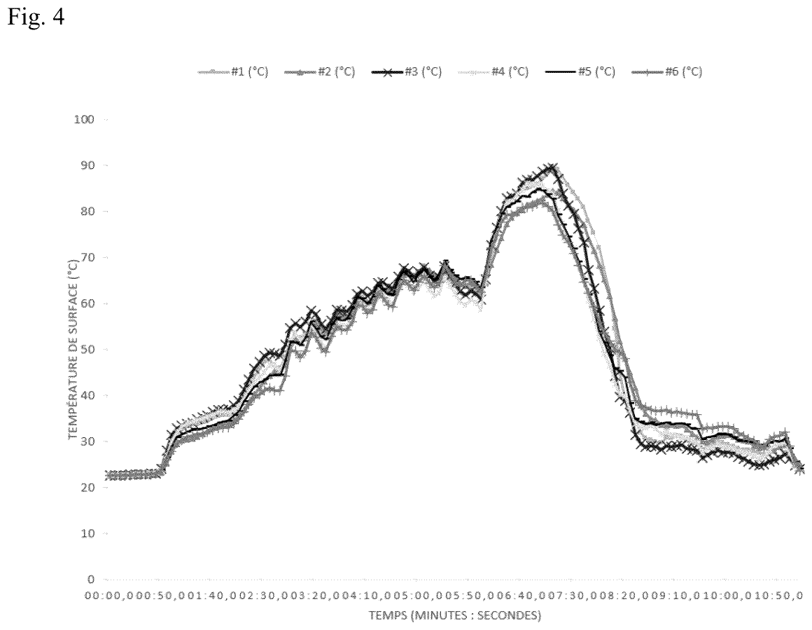

Some of these profiles are shown in FIG. 4 on a series of experiments carried out on laminated glass panels of the Stadip® 44.2 PVB type, 800 mm×600 mm in size, silvered with a 700 mg/m² thick layer on which a layer of Fenzi brand One Coat LF3 varnish, in which 0.5% by weight of para toluenesulphonic acid has been incorporated, has been applied to a thickness of 50 micrometres.

The results of these experiments can be seen in Table 1 below, in which the effects of heating are shown for each test in terms of:
bubbling of interlayer 12 (observed with the naked eye)
yellowing of interlayer 12 (observed with the naked eye)

The cross-linking of the decorative coating layer can be assessed on the basis of a so-called rub test (or abrasion resistance test), in which the number of passes required to etch this coating is assessed. More specifically, a rub test is used to determine whether a coating is sufficiently cured or cross-linked by assessing its resistance to dilution in the presence of a solvent. Generally speaking, a rub test involves soaking a cloth in a specific solvent, which is a known diluent for the coating material to be tested. The cloth may be woven or non-woven, in natural or artificial fibres. The rub test then involves rubbing back and forth with the soaked cloth over a set distance on the surface of the coating to be tested, for example over a distance of 20 cm (centimetres). The test can be repeated at several points on the surface of the coating to be tested. The test is carried out manually or using a machine.

An example of a rub test on a laminated glass panel is as follows: using a cloth (or pad) made of cellulose reinforced with polypropylene or polyester (“heavy duty cleaning cloth” reference 530276 from TORK®) measuring 200 mm*100 mm, the cloth being saturated with a solvent and having a contact surface area with the panel to be tested of 3 cm², back and forth across the surface of the panel over a distance of 5 cm at a speed of movement of between 15 m/min, the pressure exerted on the coating being controlled by means of a weight of 1 kg and therefore equal to 32.7 kPa (kilopascals).

The solvent used to saturate the cloth is xylene, which is a known solvent for decorative coating layer 13 made from a fluid material in organic phase. The solvent used to saturate the cloth may be water if the decorative coating has been made from a water-based fluid.

The decorative coating layer 13 is said to be correctly cross-linked if the decorative coating layer is not dissolved in the solvent saturating the cloth after a predetermined number N of passages. In particular, the predetermined number N of passages can be greater than or equal to 20, greater than or equal to 30, greater than or equal to 40, greater than or equal to 50, greater than or equal to 60, greater than or equal to 70, greater than or equal to 80, greater than or equal to 90, greater than or equal to 100, greater than or equal to 200, greater than or equal to 500.

TABLE 1

| | | Maximum | time (in s) during which the | | | | | |
|---|---|---|---|---|---|---|---|---|
| | Chain | surface | surface temperature is | | | | | Number |
| | speed | temperature | greater than: | | | | Yellow- | of rub test |
| Test | (m/min) | reached °C | 100 °C | 120 °C | 130 °C | bubbling | ing | passages |
| 1 | 1.5 | 90 | 0 | 0 | 0 | No | No | 20 |
| 2 | 1.5 | 102 | 25 | 0 | 0 | No | No | 20 |
| 3 | 1.5 | 131 | 220 | 85 | 10 | No | No | 30 |
| 4 | 1.0 | 120 | 304 | 0 | 0 | No | No | 30 |
| 5 | 1.0 | 119 | 280 | 0 | 0 | No | No | 50 |
| 6 | 0.7 | 130 | 472 | 218 | 0 | No | No | >200 |

Table 1 shows that the choice of temperature profile allows the cross-linking of the decorative coating layer to be controlled. Profiles 1 to 6 all achieve a rub test resistance of more than 20 passages without yellowing or bubbling of the interlayer 12.

It should be noted that these results were obtained with a proportion P_cata equal to 0.5% of para toluenesulphonic acid incorporated into the fluid material Fenzi brand One Coat LF3.

A comparison of the results obtained for the six profiles shows that the maximum surface temperature reached has an impact on cross-linking.

By comparing the results obtained for profile 4 with those obtained for profile 5, or again the results obtained for profile 3 with those obtained for profile 6, it can be seen that the speed and/or duration for which this maximum surface temperature is reached makes it possible to modulate the cross-linking of decorative coating layer 13.

Of the six temperature profiles described here, profile 6 gives very satisfactory cross-linking of the decorative coating layer 13 with a rub test resistance of more than two hundred passes. These experiments were carried out in parallel with the experiments in Example 1 and Example 2 described below.

These many experiments have made it possible for the inventors to define the characteristics of the drying step which, combined with the addition of a chemical hardener or a cross-linking catalyst to the decorative material in the fluid state, makes it possible to industrially obtain laminated glass coated with a layer of decorative coating with satisfactory chemical and/or mechanical resistance and improved optical and/or decorative properties compared to the prior art.

In particular, it has been shown that the heating time t_chauff during which the coated laminated glass panel is dried by the heating system after this heating system has reached its set point temperature T_ext, this set point temperature T_ext and the ratio P_cata of the mass of the chemical hardener or the cross-linking catalyst and the mass of the decorative material expressed as a percentage are three parameters which cannot be chosen independently of each other.

In a particular embodiment, the P_cata ratio is chosen in the range [0.1%, 5%], more particularly in the range [0.5%, 2.5%] or even more particularly [0.75%, 1.25%]. In a particular embodiment, the P_cata ratio is equal to 1%. For each of the four options for the choice of the proportion P_cata above, the set point temperature T_ext can be selected:
in the range [120 °C; 140 °C], the duration t_chauff then being less than or equal to 7.5 minutes and optionally greater than 3 minutes,
in the range [100 °C; 120 °C], the duration t_chauff then being greater than or equal to 7.5 minutes; in particular if the upper sheet of glass 11a is clear glass and is between 2 mm and 6 mm thick, and if the decorative coating layer between 50 μm and 200 μm thick before drying.

In a particular embodiment, the at least one decorative coating layer 13 consists of one or more layers of lacquer.

In another embodiment, the at least one decorative coating layer comprises at least one layer of reflective material, so as to form a mirror.

The at least one layer of reflective material can be deposited by any of the processes commonly used in silvering.

The thickness of the layer of reflective material can be adapted to obtain a silver density greater than the standard 700 mg/m². As the reflective material is subject to oxidation and of low mechanical strength, a layer of protective varnish can be applied to the layer of reflective material. The invention also relates to a laminated glass panel comprising at least two sheets of glass and in which at least two successive sheets of glass are joined together by means of a polymer interlayer material, the laminated glass panel having an upper face 11a1 and a lower face 11b1, and in which the upper face of the laminated glass panel 11a1 is coated with at least one decorative coating layer 13 formed from a fluid decorative material and in which the polymer interlayer material has no bubble defect observable to the naked eye and withstands at least twenty rub test passes, or even thirty rub test passes, fifty rub test passes, one hundred rub test passes or even two hundred rub test passes.

The adherence of decorative coating layer 13 can be quantified at a value of at most 2 in the cross cut test according to standard ISO 2409. More specifically, the cross cut test involves applying a cutting tool to the surface of decorative coating 13, applying uniform pressure to make initial incisions parallel to each other. The operation is repeated, overlapping the first incisions with second incisions at 90°, to form a grid. Adhesive tape is applied to the grid. The incisions penetrate decorative layer 13, preferably as far as the substrate. The tape is then removed at an angle close to 180°. Adherence is then assessed based on the amount of coating torn off by the removal of the adhesive tape. Value 2 corresponds to spalling along the incised edges and/or at the points where the cross cuts interact, up to just over 15% of the total grid surface. Such quantification according to the ISO2409 standard corresponds to the quantification expected for a decorative layer on monolithic glass or silvered monolithic glass.

At present, such a product can only be obtained using the process described above, for the reasons given above.

In one embodiment of the coated laminated glass panel, the polymer interlayer material is tinted. If the laminated glass panel is coated with a reflective material so as to form a mirror, this arrangement makes it possible to obtain a tinted mirror, for example a bronze colour, without having to resort to the usual processes for tinting mirrors which are cumbersome and costly to implement.

In one embodiment of the coated laminated glass panel, heating resources are incorporated either in the polymer interlayer material or in at least one of the two sheets of glass. For example, heating micro filaments can be incorporated into PVB, or one of the two sheets of glass or the glass panel can be of the EGLAS® type from Saint Gobain®. This arrangement makes it possible to obtain a heated coated glass panel, such as a heated mirror, with improved mechanical strength compared to solutions in the prior art.

Finally, the invention relates to the use of a laminated glass panel:
in the building sector, in particular for the production of decorative partition walls or floors that meet the required safety standards,
or in the furniture sector for the production of furniture comprising decorative walls or wall elements that meet the required safety standards, for example made-to-measure furniture.

### EXAMPLES

### Example 1: Cross-Linking Test

### Procedure:

A 3 mm-thick monolithic glass panel coated with Fenzi ONE COAT LF3 GREY SG varnish (Commercial reference: 23689 at the date of first priority) 100 μm thick by means of a film puller, into which varnish the para toluenesulphonic acid cross linking catalyst has first been incorporated in a proportion P_cata expressed as a percentage of the varnish weight.

The laminated glass panel coated in this way is placed in a hot air oven at a set point temperature of T_ext for a period of time t_chauff at that set point temperature.

In the case of the experiments in example 1, the time required to reach the set point temperature after inserting the laminated glass panel into the oven is of the order of 2.5 minutes, so the time taken for the laminated glass panel to pass through the hot air oven is of the order of t_chauff+2.5 minutes.

After cooling, the quality of the cross-linking of the varnish layer is assessed using the Persoz hardness test.

### Persoz Hardness Test:

The hardness test is carried out using a Persoz automatic hardness measuring pendulum, in accordance with the ISO1522 standard.

The Persoz pendulum system measures the number of oscillations of a stainless steel pendulum weighing 500 g, resting on a material (in this case on the outside of the decorative coating) via two tungsten carbide balls of a diameter of 8 mm, 50 mm apart.

A sample of coated laminated glass panel is inserted into the Persoz pendulum and placed coated face up.

The pendulum is released from an angle of 12°, and the number of oscillations N2 of the pendulum is counted until the amplitude of the oscillations reaches an angle of 4°.

The more cross-linked the paint, the harder the paint surface, and consequently the greater the number of oscillations.

### Results:

The test results are shown in Table 2 below:

TABLE 2
Number of oscillations measured in the Persoz pendulum test
depending on T_ext, P_cata and t_chauff

| | | N2 for | N2 for | N2 for | N2 for |
|---|---|---|---|---|---|
| | t_chauff | P_cata = | P_cata = | P_cata = | P_cata = |
| T_ext(°C) | (minutes) | 0.1 | 0.5 | 1% | 2.5 |
| 80 | 0 | 57 | 53 | 50 | 32 |
| 80 | 2.5 | 64 | 54 | 47 | 31 |
| 80 | 5 | 60 | 56 | 58 | 40 |
| 80 | 7.5 | 66 | 57 | 57 | 40 |
| 100 | 0 | 63 | 59 | 57 | 34 |
| 100 | 2.5 | 72 | 64 | 56 | 43 |
| 100 | 5 | 76 | 73 | 79 | 71 |
| 100 | 7.5 | 88 | 80 | 98 | 78 |
| 120 | 0 | 62 | 60 | 50 | 38 |
| 120 | 2.5 | 78 | 82 | 131 | 122 |
| 120 | 5 | 84 | 108 | 148 | 129 |
| 120 | 7.5 | 137 | 136 | 159 | 146 |
| 140 | 0 | 66 | 64 | 106 | 87 |
| 140 | 2.5 | 119 | 124 | 144 | 133 |
| 140 | 5 | 151 | 146 | 165 | 151 |
| 140 | 7.5 | 175 | 170 | 174 | 169 |
| 160 | 0 | 99 | 86 | 115 | 80 |
| 160 | 2.5 | 172 | 168 | 140 | 128 |
| 160 | 5 | 192 | 193 | 144 | 132 |
| 160 | 7.5 | 193 | 201 | 152 | 143 |

It can be seen that whatever the proportion of P_cata catalyst tested between 0.1% and 2.5%, a heating time t_chauff of less than or equal to 10 minutes (a time typically compatible with an industrialised process), at a set point temperature T_ext=80 °C, does not make it possible to obtain satisfactory cross-linking, i.e. in this case a number of oscillations greater than or equal to 150 using the Persoz test.

The same applies to a set point temperature T_ext=100 °C.

From T_ext=120 °C, it can be seen that it is possible to obtain satisfactory cross-linking provided that the heating time t_chauff and the proportion of catalyst P_cata are related to the set point temperature T_ext.

In particular, the combinations:
T_ext=120 °C, t_chauff=7.5 minutes and P_cata=1%;
T_ext=140 °C, t_chauff=7.5 minutes and P_cata=0.1%; 0.5%; 1% or 2.5%;
T_ext=140 °C, t_chauff=5 minutes and P_cata=0.1%; 1% or 2.5%;
T_ext=160 °C, t_chauff=2.5 minutes and P_cata=0.1% or 0.5%;
T_ext=160 °C, t_chauff=5 minutes and P_cata=0.1% or 0.5%;
T_ext=160 °C, t_chauff=7.5 minutes and P_cata=0.1%, 0.5% or 1%;
make it possible to obtain satisfactory cross-linking, i.e. for this series of experiments, a number N2 of oscillations greater than or equal to 150 using the Persoz test.

### Conclusion:

The experiment in Example 1 shows that, counter-intuitively, the quality of cross-linking does not always vary in the same direction as the proportion P_cata. In particular, too high a proportion of P_cata can be counter-productive.

The experience of example 1 also proves that obtaining correct cross-linking of the decorative coating layer 13 depends on the combination of three parameters: the temperature at which the laminated glass panel is heated after application of the decorative material in the fluid state in which a chemical hardener or cross-linking catalyst is incorporated, the proportion of chemical hardener or cross-linking catalyst, and the duration of this heating for drying.

This example is to be combined with the assessment of the bubbling of the polymer interlayer material forming interlayer 12 and optionally the yellowing of this material. To avoid bubbling, the pairing (set point temperature T_ext, heating time at this set point temperature t_chauff) must be chosen appropriately, the heating time being correlated to the proportion P_cata.

### Example 2: Estimating Parameters T_Ext, t_Chauff and P_Cata

A simplified model is used to estimate the parameters for the drying step of the decorative coating layer.

### Model Assumptions:

As a first approach, it is assumed that the system formed by the upper sheet of glass 11a and the decorative coating layer 13 has, at time t, a homogeneous temperature T(t) and is placed in contact with a thermostat at temperature T₀ (T₀ being equal to T_ext when the coated laminated glass panel is placed in a hot air oven having reached its set point temperature T_ext).

Between two instants t and t+dt, the temperature T satisfies the following differential equation:

$$h S ( T - {T}_{0} ) = ρ c V \frac{dT}{dt} \qquad [ Math 1 ]$$

Where V is the volume of the system, S is the surface area of the system in contact with the thermostat, c is the heat capacity of the system, p is the density of the system and h is the exchange coefficient characterising heat transfer between the system and the thermostat.

The solution to this differential equation is written as:

$$\frac{T ( t ) - {T}_{0}}{{T}_{i} - {T}_{0}} = exp ( - \frac{h S}{ρ c V} t ) \qquad [ Math 2 ]$$

where Tᵢ=T(t=0)

The temperature of the upper sheet of glass 11a and of the decorative coating layer therefore follows an exponential-type trend with a characteristic time t where:

$$τ = \frac{ρ c V}{h S} = \frac{ρ c e}{h} \qquad [ Math 3 ]$$

where e=V/S is the thickness of the system in the stacking direction (Z′Z) of the coated laminated glass panel.

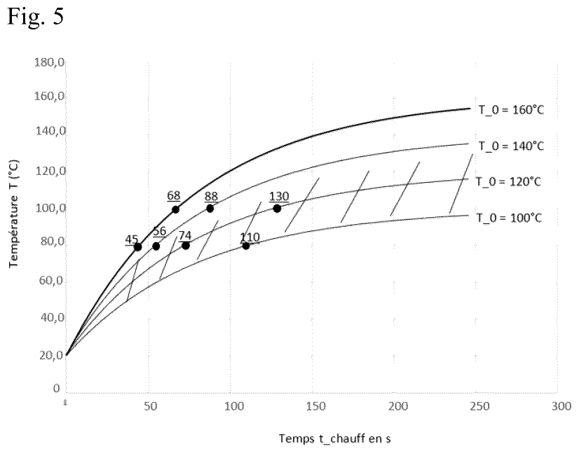

An example of this evolution is shown in FIG. 5 as an example using the following parameters:
ρ=density of glass=2530 kg/m³
c=mass heat capacity of glass=800 J/kg/K
h=100 W/m²/K
Tᵢ=T(t=0)=20 °C.

With these parameters, the characteristic time t of temperature variations T is of the order of 80 seconds.

### Conclusion:

Under the assumptions of this simplistic model, it can be seen that when heated to T_ext=160 °C, the temperature T of the coated upper sheet of glass 11a quickly reaches T=80 °C and then T=100 °C, after 45s and 68s respectively.

The temperature rise is rapid, with a steady-state limit temperature above the bubbling temperature of the polymer interlayer material. Thus, in these heating conditions, the polymer interlayer material will begin to bubble after a relatively short heating time t_chauff, particularly at the edges of the laminate where heat exchange with the interlayer 12 is amplified, and will then bubble into the mass of this interlayer 12.

It can also be seen that the time required for the temperature T of the system to rise from T=80 °C to T=100 °C naturally increases as T₀ decreases, making it possible to increase the heating time t_chauff to complete the cross-linking of the varnish without causing the PVB to bubble.

A more complex purely theoretical modelling and/or experimental results can be used to select T_ext, t_chauff and P_cata.

In particular, if the Biot number of the system is such that the assumption about the homogeneity of the temperature T is not verified experimentally, it can be agreed that, as a precaution, to avoid bubbling of the polymer interlayer material, heating should be stopped at the latest when the temperature T of the system is equal to the limit temperature T_lim for which bubbling of the polymer interlayer material is observed, from which a safety margin M_see is subtracted.

In addition, the decorative coating layer 13, however thin it may be, acts as a heat shield to delay heat transfer.

The thermal effusivity of the glass making up the upper sheet of glass 11a can also have an impact on the characteristic time of heat transfer to the polymer interlayer material.

For example, all these influencing factors can be taken into account by considering that the drying step parameters must be chosen so that the temperature T_max reached by the system, and in particular by the external surface of the system, after a heating time t_chauff is equal to T_lim-M_sec.

In particular, in the case of the coated laminated glass panel used for example 1, of which the polymer interlayer material is PVB, the combination of heating times t_chauff and temperature T_ext=T_0 corresponding to the hatched area in FIG. 5 between the curves T_0=100 °C and T_0=140 °C may be considered suitable, provided that the proportion of chemical hardener or cross-linking catalyst is compatible with the corresponding heating times t_chauff.

### LIST OF REFERENCE SIGNS

1: coated laminated glass panel
11a: upper sheet of glass
11a1: upper face of the laminated glass panel to be coated
11b: bottom sheet of glass
11b1: underside of laminated glass panel to be coated
12: interlayer of polymer material
13: decorative coating layer

1. A method of coating a laminated glass panel comprising:
a laminated glass panel to be coated is provided, comprising at least two sheets of glass (11a, 11b) and in which at least two successive sheets of glass are assembled by means of a polymer interlayer material forming, after assembly, an interlayer (12), the laminated glass panel to be coated having at least one upper face (11a1) to be coated;
a fluid decorative material is provided;
a chemical hardener or a cross-linking catalyst is incorporated into the fluid decorative material in a ratio P_cata between the mass of the chemical hardener or cross-linking catalyst and the mass of the decorative material in the determined fluid state;
at least one decorative coating layer (13) is formed by applying the decorative material in the fluid state, in which the chemical hardener or the cross linking catalyst is incorporated, to the upper face (11a1) of the laminated glass panel to be coated;
the decorative coating layer is dried by heating the laminated glass panel thus coated by means of a drying system, the set point temperature (T_ext) of which is greater than or equal to 100 °C and less than 140 °C.

2. A method of coating a laminated glass panel according to claim 1 wherein the polymer interlayer material is selected from polyvinyl butyral, ethylene vinyl acetate, an ionoplast polymer, thermoplastic polyurethane and a casting resin.

3. A method for coating a laminated glass panel according to claim 1, in which the at least one decorative coating layer consists either of a layer of reflective material and one or more layers of protective varnish or of one or more layers of lacquer and optionally of one or more layers of protective varnish.

4. A method for coating a laminated glass panel according to claim 1, in which the ratio P_cata of the mass of the chemical hardener or cross linking catalyst and the mass of the decorative material in the fluid state is greater than 0.1%.

5. A method for coating a laminated glass panel according to
claim 1 in which:
if the set temperature of the drying system (T_ext) is chosen in the range [100 °C, 120 °C], said heating time (t_chauff) by means of the drying system is greater than or equal to 7.5 minutes and said ratio P_cata is chosen in the range [0.1%; 5%],
and if the set point temperature of the drying system (T_ext) is chosen in the range [120 °C, 140 °C], said heating time (t_chauff) by means of the drying system is less than or equal to 7.5 minutes and greater than or equal to 3 minutes and said ratio P_cata is chosen in the range [0.1%; 5%].

6. A method for coating a laminated glass panel according to claim 1, in which the chemical hardener or the cross linking catalyst is chosen from acid catalysts and optionally from hydrofluoric acid, phosphoric acid and para toluenesulphonic acid.

7. A method according to claim 1 comprising a step in which the heating time (t_chauff) of the laminated glass panel at the set point temperature (T_ext) and/or the ratio P_cata of the mass of the chemical hardener or cross linking catalyst and of the mass of the decorative material in the fluid state during incorporation is determined depending on said set point temperature (T_ext).

8. A laminated glass panel comprising at least two sheets of glass and in which at least two successive sheets of glass are assembled by means of a polymer interlayer material, the laminated glass panel having a first outer face (11a1) referred to as the upper face (11a1) and a second outer face (11b1) referred to as the lower face (11b1), the panel being characterized in that the upper face (11a1) of the laminated glass panel is coated with at least one decorative coating layer (13) formed at least in part from an organic fluid decorative material applied to the upper face (11a1) of the laminated glass panel after the at least two successive sheets of glass have been assembled by means of the polymer interlayer material.

9. A laminated glass panel according to the previous claim in which: the polymer interlayer material does not have any bubbling defects observable to the naked eye, and the decorative coating layer (13) withstands at least twenty passages of a rub test carried out by rubbing the surface of the decorative coating layer (13) over a determined distance using a cloth soaked in a solvent for the decorative coating layer (13).

10. A laminated glass panel according to claim 9, the decorative coating layer (13) of which withstands at least two hundred rub-test passes.

11. A laminated glass panel according to claim 8 in which the at least one decorative coating layer consists of:
either a layer of reflective material and one or more layers of protective varnish,
or one or more layers of lacquer and optionally one or more layers of protective varnish.

12. A laminated glass panel according to claim 8 in which the polymer interlayer material is tinted.

13. A laminated glass panel according to claim 8 in which heating resources are incorporated in the polymer interlayer material or in at least one of the at least two sheets of glass.

14. Use of a laminated glass panel according to claim 8 in the building or furnishing sector.
